(19) United States
(12) Patent Application Publication
(10) Pub. No.: US 2026/0366979 A1
(43) Pub. Date: Nov. 19, 2026

(54) FINE PARTICLE CONCENTRATION MEASUREMENT SYSTEM

(71) Applicant: KOREA UNIVERSITY RESEARCH AND BUSINESS FOUNDATION, Seoul (KR)

(72) Inventors: Hyung-Min LEE, Seoul (KR); Seung-Beom KU, Seongnam-si (KR)

(73) Assignee: KOREA UNIVERSITY RESEARCH AND BUSINESS FOUNDATION, Seoul (KR)

(21) Appl. No.: 19/649,650

(22) Filed: Apr. 16, 2026

(30) Foreign Application Priority Data
May 15, 2025 (KR) 10-2025-0063466

(51) Int. Cl. G01N 15/06

(52) U.S. Cl. CPC G01N 15/06

(57) ABSTRACT

A sensor driver for measuring a concentration of fine particles in conjunction with an RF MEMS sensor may include: a driving circuit configured to drive the RF MEMS sensor; and a digital phase-amplitude detection circuit configured to receive an output signal of the RF MEMS sensor and extract amplitude information and phase information therefrom, wherein the driving circuit may compensate, in real time, an RF signal applied to the RF MEMS sensor according to a change in impedance of the RF MEMS sensor.

### CROSS-REFERENCE TO RELATED APPLICATION

This application claims the benefit of priority under 35 U.S.C. §119(a) to Korean Patent Application No. 10-2025-0063466, filed on May 15, 2025, the entire contents of which is incorporated herein by reference.

### BACKGROUND

### a. Technical Field

The present disclosure relates to a fine particle concentration measurement system.

### b. Background Art

Due to the direct and indirect impacts of the recent COVID-19 pandemic, changes in industrial activities and living environments have accelerated, resulting in an increase in the frequency of occurrence and concentration of fine particles in various environments. Fine particles generally refer to very small particles having a size of less than 10 μm, and are widely generated not only by natural phenomena but also by artificial activities, such as manufacturing processes, emissions from transportation, treatment of industrial waste, and the use and disposal of household products.

These fine particles may spread through various environments, such as the atmosphere, water, and soil, and may adversely affect ecosystems. Furthermore, the fine particles may pose serious risks to human health. In particular, several studies have reported cases in which fine particles introduced into the body through the respiratory system and digestive system were detected in tissues and bodily fluids, which may cause long-term deterioration of health (see FIG. 1).

Currently, techniques used to precisely analyze the concentration of fine particles include thermogravimetric analysis–Fourier transform infrared spectroscopy (TGA-FT-IR), Raman spectroscopy, pyrolysis gas chromatography-mass spectrometry (Pyrolysis GC-MS), thermal desorption gas chromatography/mass spectrometry (TDS-GC/MS), and thermal extraction-desorption gas chromatography/mass spectrometry (TED-GC-MS). Although these techniques provide excellent analytical accuracy, they have limitations in that they require expensive equipment, take a long time for analysis, and require skilled personnel. In addition, because they are difficult to apply in the field and are often limited to one-time analysis, they are unsuitable for high-frequency, real-time monitoring in industrial sites or living environments.

Meanwhile, attempts have also been made to estimate the presence of fine particles through transmission coefficient (S-parameter) analysis based on RF sensors. As shown in FIG. 2, a method of measuring a transmission coefficient (S₂1), which is a parameter in the analog domain, is vulnerable to various factors such as signal offset, impedance mismatch, and signal distortion caused by temperature and voltage variations. For this reason, analog-based sensing systems have a technical limitation in that they lack accuracy and reliability in quantitative analysis and repeated precise measurement with respect to changes in fine particle concentration.

Accordingly, there is an urgent need to develop a high-resolution digital-based measurement technology that can measure the concentration of fine particles more rapidly and precisely and is robust against environmental changes.

### SUMMARY OF THE DISCLOSURE

The present disclosure is directed to providing a fine particle concentration measurement system capable of precisely and repeatedly analyzing a concentration of fine particles based on a high-resolution digital I/Q quadrature signal conversion scheme.

The present disclosure is also directed to providing a fine particle concentration measurement system based on digital signal processing, which converts an output signal of an RF sensor into an in-phase (I) component and a quadrature (Q) component in a digital domain and analyzes amplitude information and phase information of a transmission coefficient (S-parameter) in real time based thereon.

The present disclosure is also directed to providing a fine particle concentration measurement system capable of stable power supply over a wide bandwidth by implementing a sensor driver circuit having a frequency-power compensation function so as to overcome a limitation of the related art in which output power varies according to a driving frequency of a sensor and to operate robustly even under environmental changes.

The present disclosure is also directed to providing a fine particle concentration measurement system capable of achieving miniaturization and cost reduction of the system and securing applicability suitable for real-time monitoring in industrial sites or living environments by directly measuring the concentration of fine particles on-chip without using an external coupler or measuring instrument.

According to one aspect of the present disclosure, a fine particle concentration measurement system is provided.

According to one embodiment of the present disclosure, there may be provided a sensor driver for measuring a concentration of fine particles in conjunction with an RF MEMS sensor, the sensor driver including: a driving circuit configured to drive the RF MEMS sensor; and a digital phase-amplitude detection circuit configured to receive an output signal of the RF MEMS sensor and extract amplitude information and phase information therefrom, wherein the driving circuit is configured to compensate, in real time, an RF signal applied to the RF MEMS sensor according to a change in impedance of the RF MEMS sensor.

The driving circuit may include: a voltage-controlled oscillator configured to generate an RF signal having a frequency set according to a bias voltage (VB1); a power amplifier disposed downstream of the voltage-controlled oscillator and configured to amplify the RF signal and apply the amplified RF signal to the RF MEMS sensor; and a feedback loop circuit configured to compensate, in real time, changes in amplitude and phase of an output signal occurring according to a change in impedance or a change in frequency response characteristic of the RF MEMS sensor driven by the RF signal, based on an output signal of the power amplifier.

The driving circuit may further include a power divider disposed downstream of the power amplifier, wherein the power divider may divide the output signal of the power amplifier and provide the divided output signal to the RF MEMS sensor and the feedback loop circuit.

The feedback loop circuit may include: an envelope detector configured to detect output power of the power amplifier and convert the detected output power into a voltage signal; a master loop circuit configured to calculate an error between an output of the envelope detector and a reference voltage and compensate a bias voltage of the power amplifier based on the error; and a slave loop circuit configured to adjust the bias voltage (VB1) of the voltage-controlled oscillator based on the output of the envelope detector so as to compensate an oscillation frequency.

The digital phase-amplitude detection circuit may include: a mixer configured to mix the output signal of the RF MEMS sensor with a local oscillator signal to convert the output signal into an intermediate-frequency signal; a bandpass filter (BPF) configured to selectively pass only a target frequency band of the intermediate-frequency signal; an analog-to-digital converter (ADC) configured to convert the filtered analog signal into a digital signal; a 1:2 multiplexer (MUX) and two multipliers configured to separate the digital signal into an in-phase (I) component and a quadrature (Q) component; and two digital-to-analog converters (DACs), respectively disposed downstream of the two multipliers and configured to convert the I component and the Q component into analog signals and output the analog signals.

According to another embodiment of the present disclosure, there may be provided a fine particle concentration measurement system including: an RF MEMS sensor having an impedance or frequency response characteristic that varies according to a concentration of fine particles; and a sensor driver configured to apply, to the RF MEMS sensor, an RF signal for driving the RF MEMS sensor and extract amplitude information and phase information of an output signal that varies according to the impedance or frequency response characteristic of the RF MEMS sensor, wherein the concentration of fine particles is calculated based on the amplitude information and the phase information of the output signal, and wherein the sensor driver is configured to compensate, in real time, the RF signal applied to the RF MEMS sensor according to a change in impedance of the RF MEMS sensor.

### BRIEF DESCRIPTION OF DRAWINGS

FIG. 1 is a diagram provided for describing fine particles.

FIG. 2 is a diagram provided for describing a conventional method for monitoring and measuring a concentration of fine particles.

FIG. 3 is a diagram illustrating a fine particle concentration measurement system according to an embodiment of the present disclosure.

FIG. 4 is a diagram illustrating a driving circuit of a sensor driver according to an embodiment of the present disclosure.

FIG. 5 is a diagram illustrating output power of a single power amplifier according to changes in bias voltage and frequency.

FIG. 6 is a diagram illustrating output power of a voltage-controlled oscillator according to a change in bias voltage.

FIG. 7 is a diagram illustrating output power of a sensor driver according to a change in frequency according to an embodiment of the present disclosure.

FIG. 8 is a diagram illustrating transient response simulation results of a sensor driver according to an embodiment of the present disclosure.

FIG. 9 is a diagram illustrating a digital phase-amplitude detection circuit of a sensor driver according to an embodiment of the present disclosure.

FIGS. 10-13 are diagrams illustrating transient response simulation results of a digital phase-amplitude detection circuit according to an embodiment of the present disclosure.

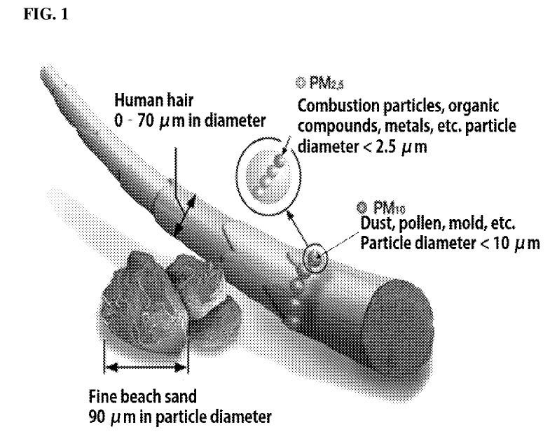

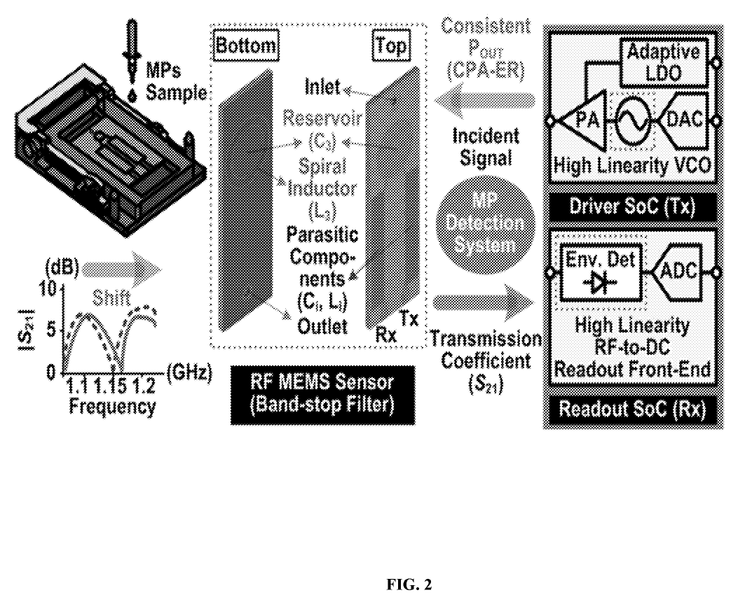

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “~ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

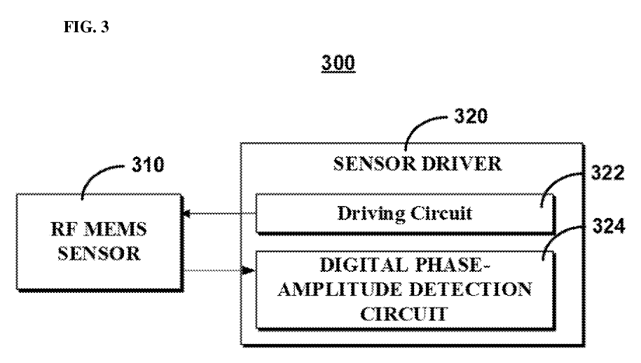

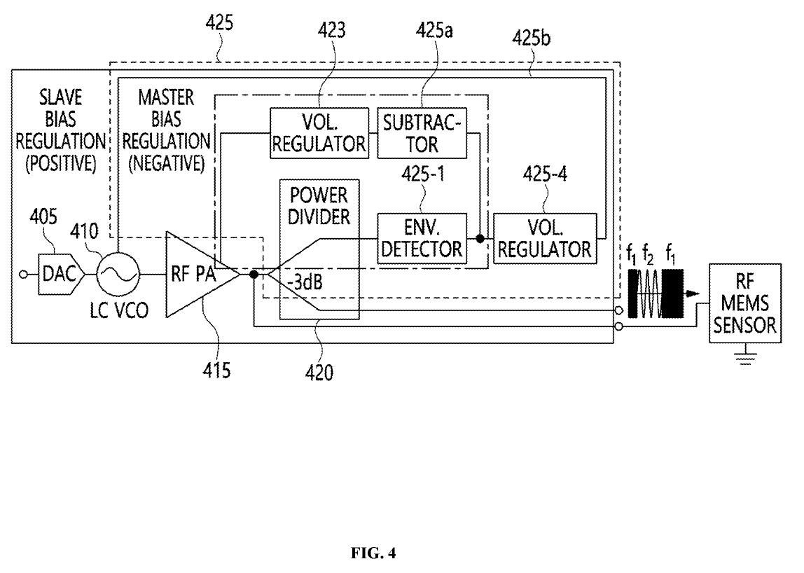

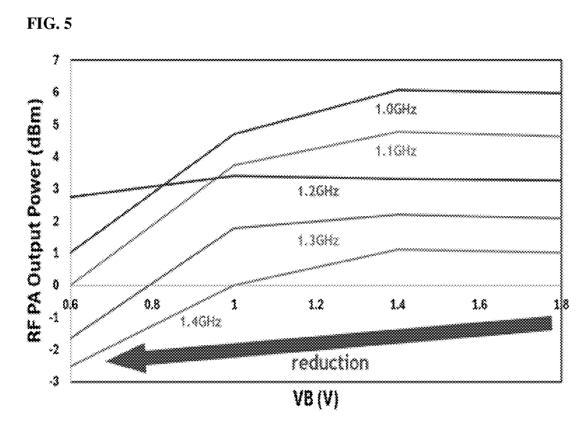

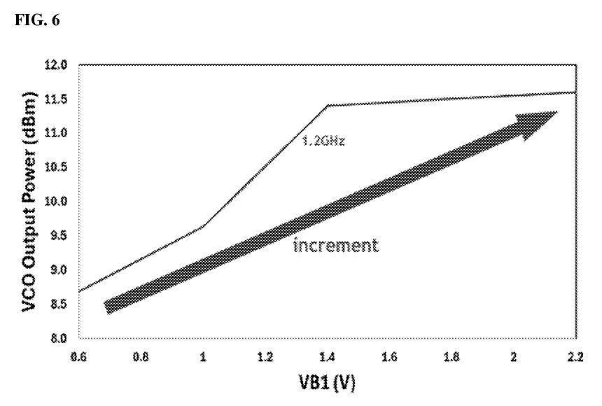

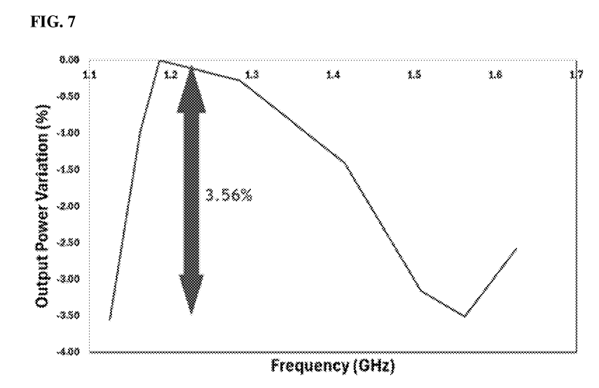

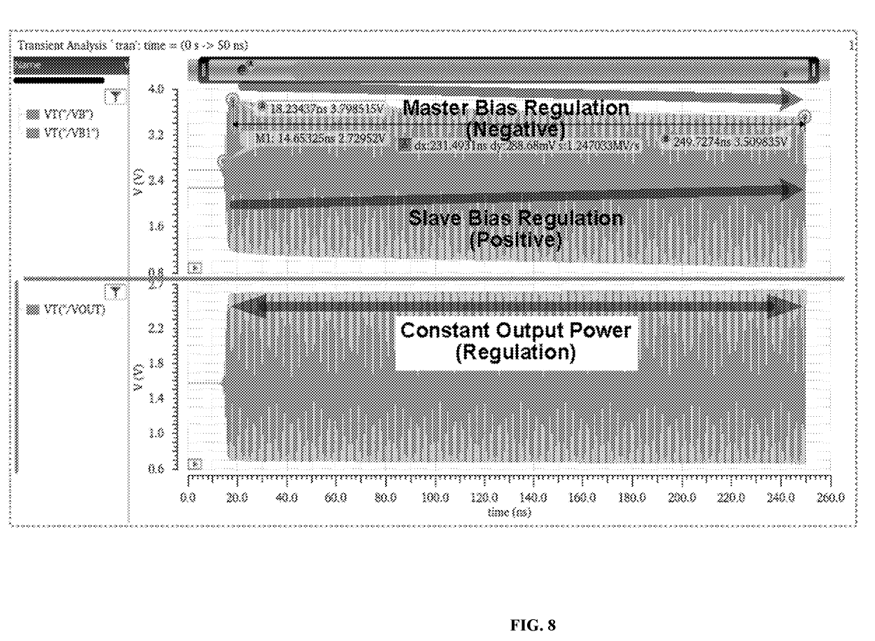

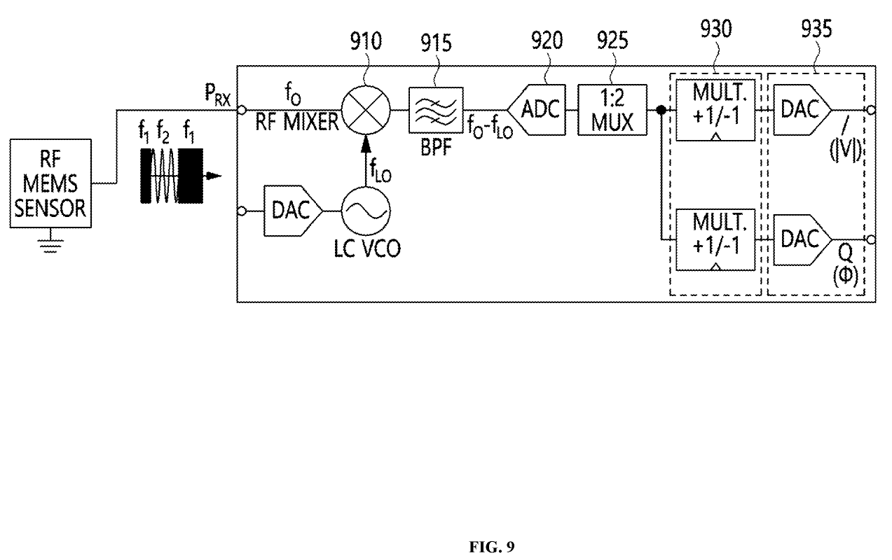

FIG. 3 is a diagram schematically illustrating a configuration of a fine particle concentration measurement system according to an embodiment of the present disclosure, FIG. 4 is a diagram illustrating a driving circuit of a sensor driver according to an embodiment of the present disclosure, FIG. 5 is a diagram illustrating output power of a single power amplifier according to changes in bias voltage and frequency, FIG. 6 is a diagram illustrating output power of a voltage-controlled oscillator according to a change in bias voltage, FIG. 7 is a diagram illustrating output power of the sensor driver according to a change in frequency according to an embodiment of the present disclosure, FIG. 8 is a diagram illustrating transient response simulation results of the sensor driver according to an embodiment of the present disclosure, and FIG. 9 is a diagram illustrating a digital phase-amplitude detection circuit of the sensor driver according to an embodiment of the present disclosure.

Referring to FIG. 3, a fine particle concentration measurement system 300 according to an embodiment of the present disclosure includes an RF MEMS sensor 310 and a sensor driver 320.

The RF MEMS sensor 310 is a passive device rather than an active device, does not have a self-oscillation function, and operates in response to an RF driving signal supplied from the outside.

That is, the RF MEMS sensor 310 may operate in response to an RF signal applied by the sensor driver 320.

The RF MEMS sensor 310 may exhibit a change in dielectric properties according to a concentration of fine particles contained in a target medium to be measured in an external environment, such as air, liquid, or fluid. Such a change in dielectric properties affects an input impedance or a frequency response characteristic of the RF MEMS sensor 310.

That is, as the concentration of fine particles increases, an effective permittivity (ε) or a loss tangent (tanδ) within a channel of the RF MEMS sensor 310 changes, and as a result, amplitude and phase characteristics of a transmission coefficient (S₂₁) and a reflection coefficient (S₁₁) of the RF MEMS sensor 310 are changed together.

More specifically, a change in the impedance of the RF MEMS sensor 310 directly affects a reflection coefficient (S₁₁) at a sensor input terminal. When a permittivity increases or a loss tangent increases as the concentration of fine particles increases, an input impedance of the sensor becomes mismatched with a reference impedance, such that a portion of an incident RF signal is reflected, and as a result, an amplitude and a phase of the reflection coefficient (S₁₁) may vary.

In general, since fine particles have a higher permittivity than air, as particle density increases, an average permittivity of a dielectric affecting an electric field distribution inside the sensor increases. This results in an increase in capacitance within the RF MEMS sensor 310, thereby causing a decrease in input impedance or a shift in resonance frequency.

Further, when the fine particles include moisture, polymer components, carbon components, or the like, the fine particles may cause dielectric loss in a high-frequency band. Accordingly, a loss tangent (tanδ), which represents a loss component of an internal path of the RF MEMS sensor 310, increases, leading to an increase in insertion loss and a decrease in amplitude of a transmission coefficient (S₂₁).

Such changes in dielectric properties are reflected in a response signal of the RF MEMS sensor and observed as phase delay and amplitude attenuation, and may be detected in real time through the sensor driver 320 and used for measuring the concentration of fine particles.

The sensor driver 320 may supply an RF signal to the RF MEMS sensor 310 and may receive and analyze a response of the RF MEMS sensor 310.

The sensor driver 320 may include a driving circuit 322 and a digital phase-amplitude detection circuit 324.

The driving circuit 322 is configured to supply an RF signal to the RF MEMS sensor 310. When output power or phase characteristics are changed due to a change in impedance of the RF MEMS sensor 310, the driving circuit 322 may compensate, through a master-slave loop circuit, an output signal applied to the RF MEMS sensor and an oscillation frequency in real time.

FIG. 4 illustrates a circuit diagram of the driving circuit 322.

The driving circuit 322 will now be described in greater detail with reference to FIG. 4.

Referring to FIG. 4, the driving circuit 322 according to an embodiment of the present disclosure includes a digital-to-analog converter (DAC) 405, a voltage-controlled oscillator (VCO) 410, a power amplifier (RF PA) 415, a power divider 420, and a feedback loop circuit 425.

The voltage-controlled oscillator 410 is configured to generate a sinusoidal output. That is, the voltage-controlled oscillator 410 may generate an RF signal having a frequency set according to a bias voltage (VB1). The oscillation frequency of the voltage-controlled oscillator 410 is delivered to a mixer of the digital phase-amplitude detection circuit 324 and mixed with a response signal of the RF MEMS sensor 310 to generate an intermediate frequency signal. In this case, the voltage-controlled oscillator 410 serves as a local oscillator, and its output frequency is used as a reference frequency for the digital detection circuit so that phase and amplitude information of the sensor response signal can be stably analyzed in an intermediate frequency band.

The digital-to-analog converter (DAC) 405 converts a digital control signal for controlling a bias voltage into an analog voltage.

The power amplifier (RF PA) 415 is disposed downstream of the voltage-controlled oscillator 410 and may amplify and output the RF signal output from the voltage-controlled oscillator 410.

The signal output from the power amplifier 415 may be divided by the power divider 420 and respectively transmitted to the RF MEMS sensor 310 and the feedback loop circuit 425.

The RF MEMS sensor 310 is driven by application of the divided output signal (RF signal), and when a sample is supplied through a channel, the RF MEMS sensor 310 outputs a corresponding response signal based on impedance characteristics that vary according to a concentration of fine particles in the sample.

That is, as the sample passes through the channel of the RF MEMS sensor 310, electromagnetic properties of the sample to be measured within the channel, for example, permittivity and loss tangent, affect an electric field distribution and resonance characteristics, such that an input impedance or frequency response of the RF MEMS sensor 310 changes and is reflected in the output response signal.

The channel is disposed between electrode structures of the RF MEMS sensor 310, and as a sample supplied from the outside passes through or fills the channel, effective dielectric properties of the RF MEMS sensor 310 change in real time. As a result, response characteristics to the RF driving signal are changed, so that amplitude or phase characteristics of the response signal are changed.

The output signal (i.e., the amplified RF signal) from the power amplifier 415 may exhibit changes in amplitude or phase characteristics according to a change in load impedance of the RF MEMS sensor 310. That is, when the impedance of the RF MEMS sensor 310 decreases or loss thereof increases, power delivery efficiency of the power amplifier 415 decreases, resulting in a reduction in output amplitude. Alternatively, a variation in output phase may occur due to a change in resonance characteristics of the RF MEMS sensor 310.

To compensate for such changes in the output signal, the feedback loop circuit 425 detects the output signal of the power amplifier, compares amplitude or phase variations of the output signal with a reference voltage, and adjusts bias voltages of the power amplifier and the voltage-controlled oscillator in real time, thereby stabilizing driving power applied to the RF MEMS sensor and ensuring that the response signal of the sensor is accurately acquired under consistent conditions.

This will be described in greater detail below.

As shown in FIG. 4, the feedback loop circuit 425 includes an envelope detector 425-1, a master loop circuit 425a, and a slave loop circuit 425b.

The envelope detector 425-1 is configured to detect the output signal (i.e., the amplified RF signal) of the power amplifier 415 transmitted through the power divider 420 and convert the detected output signal into a voltage signal.

The master loop circuit 425a calculates a difference (error) between the output (voltage signal) of the envelope detector 425-1 and a reference voltage, and compensates a bias voltage of the power amplifier based on the error.

As shown in FIG. 4, the master loop circuit 425a includes a subtractor 425-2 and a first voltage regulator 425-3.

The subtractor 425-2 is configured to calculate a difference between the output (voltage signal) of the envelope detector 425-1 and a preset reference voltage and to output an error voltage.

The first voltage regulator 425-3 receives the error voltage output from the subtractor 425-2 and adjusts, in real time, the bias voltage applied to the power amplifier 415, thereby compensating such that the output signal of the power amplifier 415 is maintained within a reference output range.

The master loop circuit 425a may detect a variation in the output signal (power) caused by a change in load impedance of the RF MEMS sensor 310 and compensate for the variation in real time, thereby supplying a stable RF signal to the RF MEMS sensor 310.

The slave loop circuit 425b includes a second voltage regulator 425-4.

The second voltage regulator 425-4 receives the output of the envelope detector 425-1 and adjusts the bias voltage (VB1) applied to the voltage-controlled oscillator 410, thereby compensating such that the oscillation frequency of the RF signal output from the voltage-controlled oscillator 410 is maintained within a target operating range.

When output characteristics of the power amplifier and a frequency response of the overall system change due to a change in impedance of the RF MEMS sensor 310 or a change in an external environment, the slave loop circuit 425b automatically adjusts the bias voltage of the voltage-controlled oscillator, thereby guiding the operating condition to an optimum frequency response point of the sensor.

As described above, the master loop circuit 425a and the slave loop circuit 425b operate complementarily with each other and may actively compensate for frequency dependence according to driving conditions of the RF MEMS sensor 310 by adjusting bias conditions of the power amplifier and the voltage-controlled oscillator in real time. Through this, even when sensor load impedance or external environmental conditions change, RF driving power (i.e., output power) applied to the RF MEMS sensor 310 may be maintained substantially constant over a wide bandwidth (for example, within 500 MHz). As a result, reliability and measurement accuracy of the fine particle concentration measurement system as a whole may be improved.

As shown in FIGS. 5 and 6, a conventional sensor driver structure includes a single power amplifier and a single voltage-controlled oscillator, and tends to exhibit a linear increase in output power as the bias voltage increases.

However, such a structure has a drawback in that output power cannot be maintained stably when a driving frequency changes or when sensor load conditions vary.

As shown in FIG. 7, the sensor driver 320 according to an embodiment of the present disclosure includes a bias-voltage control mechanism through the master-slave loop circuit, and it can be confirmed that a rate of change in output power is maintained within a maximum of 3.56% over a wide bandwidth of 500 MHz. This indicates significantly improved power stability compared with a conventional single-bias structure.

Further, as shown in FIG. 8, the sensor driver 320 according to an embodiment of the present disclosure may maintain constant output power despite variations in driving frequency by detecting the output power in real time and independently adjusting bias voltages (VB and VB1) of the power amplifier and the voltage-controlled oscillator.

In particular, it was experimentally demonstrated that a negative-feedback-based master loop configured to suppress amplitude variations in output power and a positive-feedback-based slave loop configured to compensate for variations in oscillation frequency operate complementarily, thereby maximizing dynamic stability of the overall system with respect to impedance changes of the RF MEMS sensor 310 and further reducing frequency dependence.

Referring again to FIG. 3, the digital phase-amplitude detection circuit 324 is configured to detect amplitude information and phase information after receiving a response signal of the RF MEMS sensor 310. The digital phase-amplitude detection circuit 324 may mix the response signal of the RF MEMS sensor 310 with a reference frequency signal to convert the response signal into an intermediate frequency signal, convert the intermediate frequency signal into a digital domain, and separate the intermediate frequency signal into an in-phase (I) component and a quadrature (Q) component, thereby quantitatively extracting amplitude and phase values of the signal.

Amplitude information and phase information detected in this manner are transmitted to a signal processor disposed downstream, and the signal processor may quantitatively calculate a concentration of fine particles based on the amplitude information and the phase information according to a predefined calibration model or mathematical equation.

As shown in FIG. 9, the digital phase-amplitude detection circuit 324 includes an RF mixer 910, a bandpass filter (BPF) 915, an analog-to-digital converter (ADC) 920, a 1:2 multiplexer 925, a multiplier 930, and a digital-to-analog converter (DAC) 935.

The RF mixer 910 may mix the output signal of the RF MEMS sensor 310 with a reference frequency signal, that is, a local oscillation frequency (f_{LO}), to convert the output signal into an intermediate-frequency (IF) component.

In the RF MEMS sensor 310, input impedance and loss characteristics vary according to the concentration of fine particles. As a result, insertion loss of the sensor varies, and accordingly, the magnitude of power at which the sensor response is output is determined dependently on a driving frequency (f₀) of the sensor. The signal of the RF MEMS sensor 310, which varies according to the driving frequency, is mixed with the local oscillation frequency (f_{LO}) in the RF mixer 910 to generate a sum-frequency component and a difference-frequency component, and among these, only a target intermediate-frequency (IF) component is transmitted to the bandpass filter 915 connected downstream.

The bandpass filter 915 may pass only a target frequency component from among the intermediate-frequency signals. That is, the bandpass filter 915 serves to selectively pass only a target frequency component from among the intermediate-frequency (IF) signals output through the RF mixer 910, for example, a frequency component corresponding to a difference (f₀ − f_{LO}) between the driving frequency (f₀) and the local oscillation frequency (f_{LO}).

Although the output of the mixer 910 includes various frequency components, such as a sum frequency (f₀ + f_{LO}) and a difference frequency (f₀ − f_{LO}), in an embodiment of the present disclosure, the difference-frequency component is set as a target intermediate-frequency band, and the bandpass filter 915 removes unnecessary high-frequency or low-frequency noise other than the corresponding component so that only a stable and selective frequency signal is delivered to a downstream signal processing circuit.

The analog-to-digital converter 920 is configured to convert the target frequency signal output through the bandpass filter 915 into a digital signal.

The 1:2 multiplexer 925 is configured to separate the digital signal into an in-phase (I) component and a quadrature (Q) component, and may branch the digital signal according to respective reference phases (0° and 90°).

The multiplier 930 is configured to perform quadrature multiplication of the separated digital signal with a reference phase signal so as to extract an actual in-phase component value and a quadrature component value of each component.

The digital-to-analog converter 935 is configured to convert the I component and the Q component obtained from the output of the multiplier 930 into analog signals and output the analog signals.

The I and Q components may be transmitted to the signal processor, and the concentration of fine particles may be calculated thereby.

In particular, according to frequency response characteristics of S-parameters of the RF MEMS sensor 310, especially a transmission coefficient (S₂₁), received power (P_{RX}) at a receiving-side port (RX port) varies with frequency. Such frequency-dependent power variation characteristics result not only from changes in input impedance of the RF MEMS sensor 310, but also from changes in an internal dielectric structure and the concentration of fine particles, and such variations directly affect the downstream digital phase-amplitude detection circuit.

Accordingly, the sensor driver 320 of the present disclosure may precisely detect changes in S-parameters that vary based on the frequency response of the RF MEMS sensor 310, particularly changes in amplitude and phase characteristics of S₂₁, thereby enabling high-resolution quantitative analysis according to changes in concentration and characteristics of fine particles.

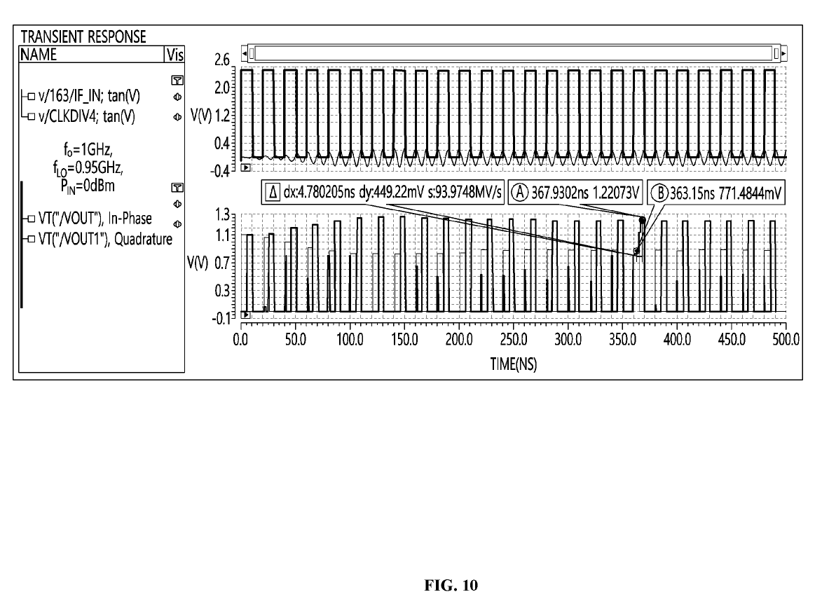

FIGS. 10-13 are diagrams illustrating transient response simulation results of the digital phase-amplitude detection circuit according to an embodiment of the present disclosure.

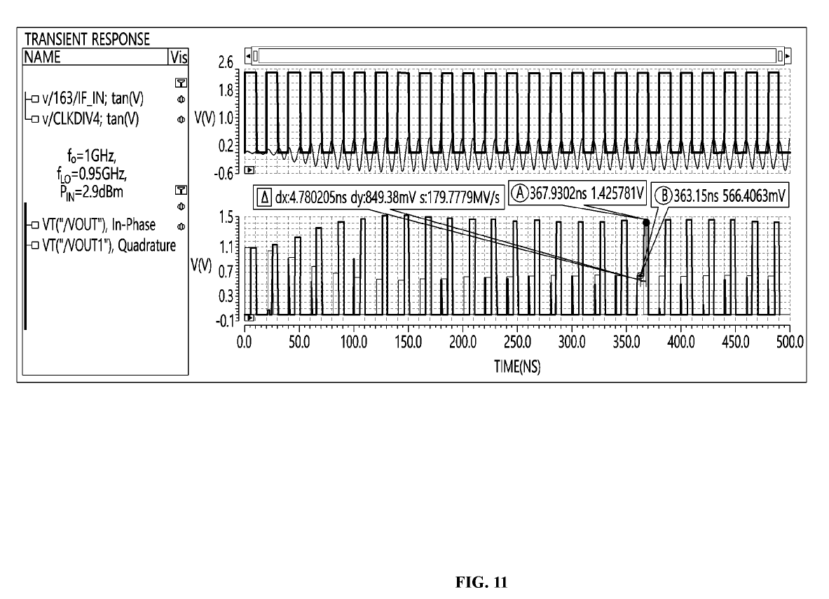

FIGS. 10 and 11 show characteristics in which magnitudes of an in-phase component and a quadrature component vary according to a change in input power (P_{IN}) under a condition in which a driving frequency (f0) and a local oscillation frequency (f_{LO}) are applied.

As the input power increases, amplitudes of the in-phase component and the quadrature component included in an output signal of the detection circuit also tend to increase, respectively. From this, it can be confirmed that the sensitivity and resolution of fine particle concentration measurement may be affected.

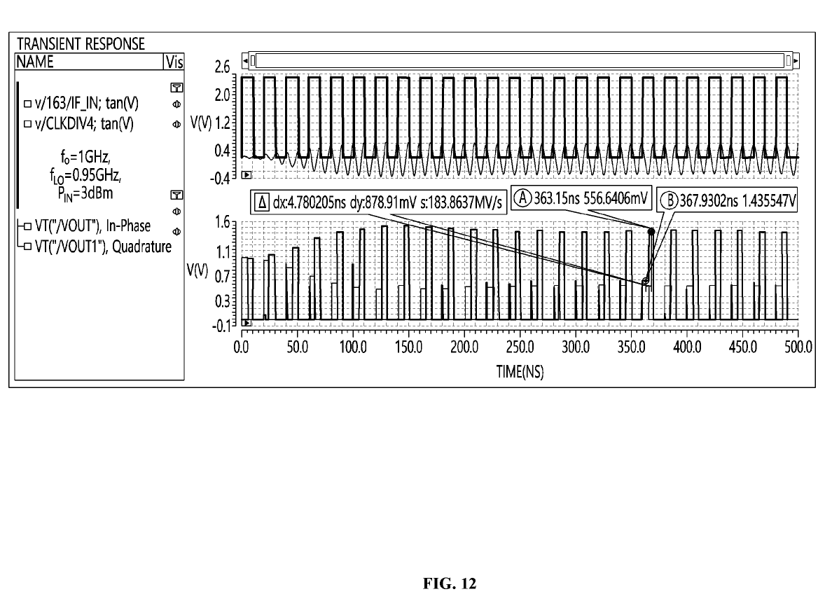

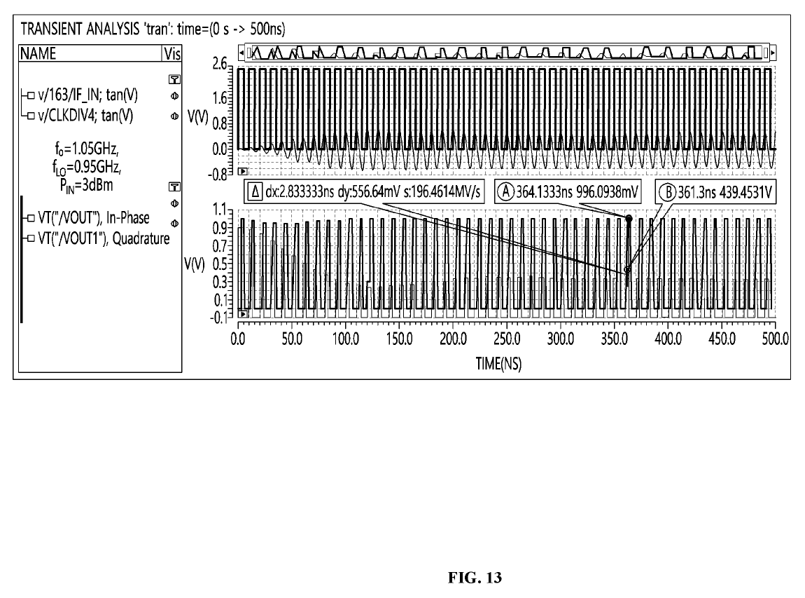

FIGS. 12 and 13 show simulation results illustrating how output characteristics of the in-phase component and the quadrature component change when the intermediate frequency (f_{IF} = f₀ − f_{LO}) varies under a condition in which the input power (P_{IN}) is the same. In particular, amplitude and phase responses of the output signal are different at a higher intermediate frequency (f_{IF}) than at a lower intermediate frequency (f_{IF}). As a result, this indicates that differences in frequency selectivity and detection sensitivity according to the intermediate frequency (f_{IF}) should be taken into consideration, and that magnitudes of the in-phase component and the quadrature component may vary nonlinearly according to the intermediate frequency (f_{IF}).

The apparatus and method according to embodiments of the present disclosure may be implemented in the form of program instructions executable through various computer means and may be recorded on a computer-readable medium. The computer-readable medium may include program instructions, data files, data structures, or combinations thereof. The program instructions recorded on the computer-readable medium may be those specially designed and configured for the present disclosure, or those known to and available to persons having ordinary skill in the field of computer software. Examples of computer-readable recording media include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, flash memory, and the like. Examples of program instructions include not only machine-language code produced by a compiler but also high-level language code that can be executed by a computer using an interpreter or the like.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A sensor driver for measuring a concentration of fine particles in conjunction with an RF MEMS sensor, the sensor driver comprising:
a driving circuit configured to drive the RF MEMS sensor; and
a digital phase-amplitude detection circuit configured to receive an output signal of the RF MEMS sensor and extract amplitude information and phase information therefrom,
wherein the driving circuit is configured to compensate, in real time, an RF signal applied to the RF MEMS sensor according to a change in impedance of the RF MEMS sensor.

2. The sensor driver of claim 1,
wherein the driving circuit comprises:
a voltage-controlled oscillator configured to generate an RF signal having a frequency set according to a bias voltage (VB1);
a power amplifier disposed downstream of the voltage-controlled oscillator and configured to amplify the RF signal and apply the amplified RF signal to the RF MEMS sensor; and
a feedback loop circuit configured to compensate, in real time, bias voltages of the power amplifier and the voltage-controlled oscillator based on an output signal of the power amplifier, according to a change in impedance or a change in frequency response characteristic of the RF MEMS sensor driven by the RF signal.

3. The sensor driver of claim 2,
wherein the driving circuit further comprises a power divider disposed at an output stage of the power amplifier,
wherein the power divider is configured to divide an output signal of the power amplifier between the RF MEMS sensor and the feedback loop circuit.

4. The sensor driver of claim 2,
wherein the feedback loop circuit comprises;
an envelope detector configured to detect output power of the power amplifier and convert the detected output power into a voltage signal;
a master loop circuit configured to calculate an error between an output of the envelope detector and a reference voltage, and to compensate a bias voltage of the power amplifier based on the error; and
a slave loop circuit configured to adjust the bias voltage (VB1) of the voltage-controlled oscillator based on the output of the envelope detector so as to compensate an oscillation frequency.

5. The sensor driver of claim 1,
wherein the digital phase-amplitude detection circuit comprises:
a mixer configured to mix an output signal of the RF MEMS sensor with a local oscillator signal to convert the output signal into an intermediate frequency signal;
a bandpass filter (BPF) configured to selectively pass only a target frequency band of the intermediate frequency signal;
an analog-to-digital converter (ADC) configured to convert an analog signal output from the bandpass filter into a digital signal;
a 1:2 multiplexer (MUX) and two multipliers configured to separate the digital signal into an in-phase (I) component and a quadrature (Q) component; and
two digital-to-analog converters (DACs), respectively disposed downstream of the two multipliers, and configured to convert the I component and the Q component into analog signals and output the analog signals.

6. A fine particle concentration measurement system comprising:
an RF MEMS sensor having an impedance or frequency response characteristic that varies according to a concentration of fine particles; and
a sensor driver configured to apply, to the RF MEMS sensor, an RF signal for driving the RF MEMS sensor and to extract amplitude information and phase information of an output signal that varies according to the impedance or frequency response characteristic of the RF MEMS sensor,
wherein the concentration of fine particles is calculated based on the amplitude information and the phase information of the output signal, and
wherein the sensor driver is configured to compensate, in real time, the RF signal applied to the RF MEMS sensor according to a change in impedance of the RF MEMS sensor.
